(19) United States
(12) Patent Application Publication
(10) Pub. No.: US 2008/0228828 A1
(43) Pub. Date: Sep. 18, 2008

(54) Management of collections within a data storage system

(75) Inventor: Cristian G. Teodorescu, Seattle, WA (US)

Correspondence Address: MICROSOFT CORPORATION, ONE MICROSOFT WAY, REDMOND, WA, 98052-6399, US

(73) Assignee: Microsoft Corporation, Redmond, WA (US)

(21) Appl. No.: 11/724,708

(22) Filed: Mar. 16, 2007

(51) Int. Cl. G06F 12/00

(52) U.S. Cl. 707/200; 707/E17.005

(57) ABSTRACT

Methods of managing collections within a data storage system are disclosed. Computer readable medium having stored thereon computer-executable instructions for performing methods of managing collections within a data storage system are also disclosed. Further, computing systems containing at least one application module, wherein the at least one application module comprises application code for performing methods of managing collections within a data storage system are disclosed.

### BACKGROUND

Storage systems for storing data are known. Efforts continue in the art to develop storage systems that provide exceptional reliability while maintaining storage system efficiency.

### SUMMARY

Described herein are, among other things, various technologies for automatic management of collections of data within a data storage system. Within the data storage system, collections may be created, closed, and reopened, as needed, to maintain an optimum collection size for each collection. The total number of collections in the data storage system is kept in check and adjusted, as needed, to insure parallel ingestion of a large number of data objects, while actively managing the overhead associated with the total number of collections.

This Summary is provided to generally introduce the reader to one or more select concepts describe below in the “Detailed Description” section in a simplified form. This Summary is not intended to identify key and/or required features of the claimed subject matter.

### BRIEF DESCRIPTION OF THE FIGURES

FIG. 1 depicts an exemplary process diagram showing exemplary collection states and process steps for managing collections within a data storage system;

FIG. 2 is a block diagram of some of the primary components of an exemplary operating environment for implementation of the methods and processes disclosed herein;

FIGS. 3A-3C represent an exemplary logic flow diagram showing exemplary steps for automatic management of collections of data objects within a data storage system;

FIGS. 4A-4C represent an exemplary logic flow diagram showing exemplary steps for adjusting a total number of collections so as to compensate for a change in the concurrency setting of the data storage system; and

FIGS. 5A-5D represent an exemplary logic flow diagram showing exemplary steps for controlled placement of data objects within collections of a data storage system.

### DETAILED DESCRIPTION

To promote an understanding of the principles of the methods and processes disclosed herein, descriptions of specific embodiments follow and specific language is used to describe the specific embodiments. It will nevertheless be understood that no limitation of the scope of the disclosed methods and processes is intended by the use of specific language. Alterations, further modifications, and such further applications of the principles of the disclosed methods and processes discussed are contemplated as would normally occur to one ordinarily skilled in the art to which the disclosed methods and processes pertains.

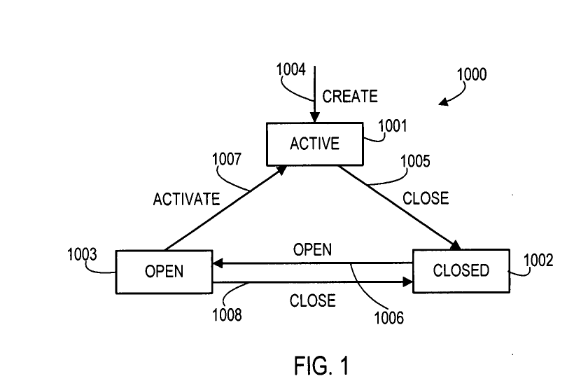

Methods for managing collections of data, such as data objects, are disclosed. As used herein, the term “data object” refers to a block of information that client applications can store in the data storage system, and access from the data storage system, independently of other blocks of information. As used herein, the term “collection” refers to a set of data objects stored by the data storage system at the same data storage locations. The disclosed methods may comprise one or more steps in order to reliably and effectively store data objects within collections on a data storage system. The disclosed methods utilize various states of collections in order to (1) maintain a collection size below or at an optimum collection size, (2) maintain a total number of collections so as to enhance performance of the data storage system (e.g., manage the overhead associated with a growing number of total collections), (3) provide a high rate of parallel data object ingest into the data storage system, and (4) allow for controlled placement of data objects (e.g., locality placement) within the collection-based storage system. Exemplary collection states (i.e., “active”, “closed”, and “open” collections) and process steps for managing collections within the disclosed data storage systems are depicted in the exemplary process diagram of FIG. 1.

FIG. 1 depicts an exemplary process diagram 1000 showing different states of collections and process steps used in the disclosed methods of managing collections. The exemplary process diagram 1000 depicts “active” collections 1001, “closed” collections 1002, and “open” collections 1003. As used herein, an “active” collection is a collection that is actively involved with and capable of receiving new data objects. As used herein, a “closed” collection is a collection that is inactive and incapable of receiving new data objects due to its collection size either approaching or exceeding an optimum collection size. As used herein, an “open” collection is a collection that was previously a “closed” collection, but due to its collection size falling a predetermined amount below an optimum collection size, is capable of being activated so as to be converted into an “active” collection.

Exemplary process diagram 1000 of FIG. 1 provides a number of exemplary steps involving the above-described states of collections. As shown by arrow 1004, methods of managing collections within the disclosed data storage systems may include creation of one or more active collections 1001. Once created, a given active collection 1001 receives new data objects until either (i) a collection size of active collection 1001 approaches or exceeds an optimum collection size or (ii) a replica of active collection 1001 approaches or exceeds an available amount of disk space on a local disk. Methods of managing collections within the disclosed data storage systems also include a method of closing a given active collection 1001 to form closed collection 1002 as shown by arrow 1005. A given active collection 1001 may be closed to form closed collection 1002 as shown by arrow 1005 due to either (i) a collection size of active collection 1001 approaching or exceeding an optimum collection size or (ii) a replica of active collection 1001 approaching or exceeding an available amount of disk space on a local disk. Closing a given active collection 1001 helps insure an optimum collection size throughout a given data storage system.

Methods of managing collections within the disclosed data storage systems may also include reopening closed collection 1002 to form open collection 1003 as shown by arrow 1006. This optional method step may be initiated if a collection size of closed collection 1002 falls below an optimum collection size, and is typically initiated when a collection size of closed collection 1002 falls a predetermined amount below an optimum collection size (e.g., 50% below the optimum collection size). In addition, methods of managing collections within the disclosed data storage systems may further include an activation step, as designated by arrow 1007, wherein an open collection 1003 is activated to form an active collection 1001. Such an activation step can be used to replace a closed collection so as to maintain a desired total number of active collections 1001. Further, methods of managing collections within the disclosed data storage systems may also include a closing step, as designated by arrow 1008, wherein an open collection 1003 is closed to form a closed collection 1002. Such a closing step can be used when a local disk hosting a replica of open collection 1003 runs out of disk space because of write ingest in other collections sharing the disk space.

As shown in FIG. 1, methods for managing collections may comprise utilizing active collections 1001, closed collections 1002, and open collections 1003. In such a system, (1) active collections 1001 may be closed to form closed collections 1002, (2) open collections 1003 may be closed to form closed collections 1002, (3) closed collections 1002 may be reopened to form open collections 1003, and (4) open collections 1003 may be activated to form active collections 1001. However, in other exemplary embodiments described herein, methods for managing collections may comprise only active collections 1001 and closed collections 1002. In these alternative exemplary embodiments, (1) active collections 1001 may be closed to form closed collections 1002, and (2) closed collections 1002 may be activated to form active collections 1001.

### Exemplary Operating Environment

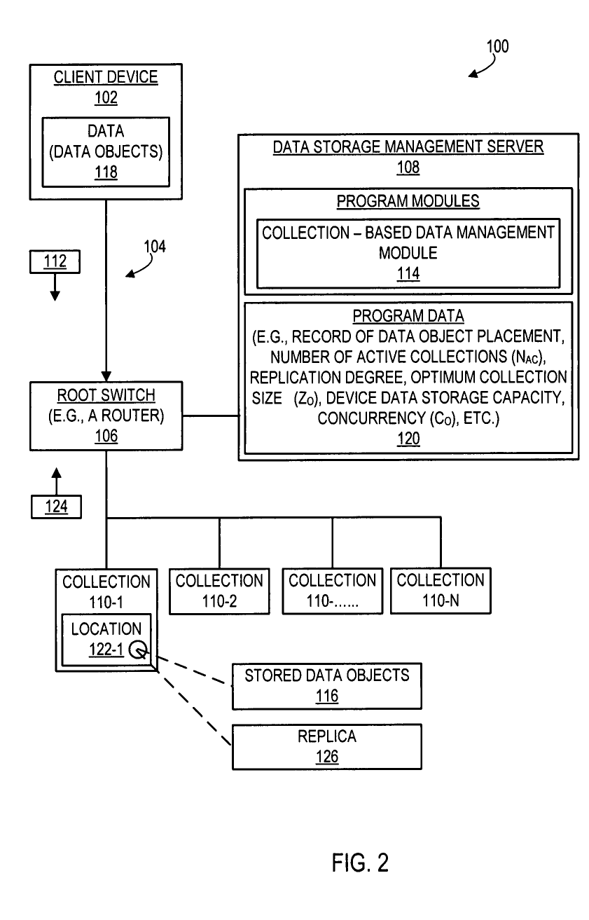

FIG. 2 illustrates an example of a suitable computing system environment 100 on which collection management methods disclosed herein may be implemented. The computing system environment 100 is only one example of a suitable computing environment and is not intended to suggest any limitation as to the scope of use or functionality of the methods disclosed herein. Neither should the computing environment 100 be interpreted as having any dependency or requirement relating to any one or combination of components illustrated in the exemplary computing system environment 100.

The methods disclosed herein are operational with numerous other general purpose or special purpose computing system environments or configurations. Examples of well-known computing systems, environments, and/or configurations that may be suitable for use with the methods disclosed herein include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The methods and processes disclosed herein may be described in the general context of computer-executable instructions, such as program modules, being executed by a computer. Generally, program modules include routines, programs, objects, components, data structures, etc. that perform particular tasks or implement particular abstract data types. The methods and processes disclosed herein may also be practiced in distributed computing environments where tasks are performed by remote processing devices that are linked through a communications network. In a distributed computing environment, program modules may be located in both local and remote computer storage media including memory storage devices.

With reference to FIG. 2, an exemplary system 100 for implementing the methods and processes disclosed herein include client computing device 102 coupled across network 104 to root switch (e.g., a router) 106, data storage management server 108 and data storage collections 110 (e.g., collections 110-1 through 110-N). Client device 102 is any type of computing device such as a personal computer, a laptop, a server, etc. Network 104 may include any combination of a local area network (LAN) and a general wide area network (WAN) communication environment, such as those which are commonplace in offices, enterprise-wide computer networks, intranets, and the Internet. Root switch 106 is a network device such as a router that connects client device(s) 102, data storage management server 108 and all data collections 110 together. All data access and data repair traffic goes through the root switch 106. Root switch 106 has bounded bandwidth for data repair, which may be used as a parameter in the disclosed collection management methods implemented by the data storage management server 108 to determine an optimal collection size.

Client device 102 sends data placement and access I/O requests 112 to the data storage management server 108. An input request 112 directs the data management server, and more particularly, collection-based data management program module 114, to distribute data objects 118 associated with the input requests 112 across one or more collections 110. For purposes of exemplary illustration, data objects 118 for distribution across collections 110 are shown as stored data objects 116. Mapping of each stored data object 116 within collections 110 is either stored as shown in FIG. 2 as a respective portion of “program data” 120 within data storage management server 108 or, alternatively, as offloaded data on client device 102. A data output (data access) request 112 directs collection-based data management module 114 to access already stored data from collections 110. Prior to processing such I/O requests 112, collection-based data management module 114 configures each collection 110 so as to implement efficient data storage within collections 110 in accordance with the disclosed methods and procedures.

The collection-based data management module 114 configures each collection 110, as well as the total number of collections 110 (N) utilizing program data 120 stored on data storage management server 108. Responsive to receiving data input requests 112, collection-based data management module 114 collects data objects 118 associated with one or more of the requests, and distributes the data objects 118 within collections 110 to create one or more stored data objects 116, as well as one or more replicas 126 at locations 122 of a given collection 110 (e.g., locations 122-1 of collection 110-1). Collection-based data management module 114 delivers each data object 118 for data storage and replication across one or more collections 110 using any desired placement scheme (e.g., a round-robin placement scheme, a locality placement scheme based on an ordinal-affinity association, or a combination thereof as described below).

The collection-based data management module 114 organizes stored data objects 116 using any standard indexing mechanisms, such as B-tree index widely used in file systems. With such an index, each individual stored data object 116 can be located within a given collection 110. Responsive to receiving a file access request 112, collection-based data management module 114 communicates the access request to the corresponding collection 110, which enables retrieval of the stored data object 116 using the index within the collection 110, and delivers corresponding data response(s) 124 to client device 102.

As mentioned above, those skilled in the art will appreciate that the disclosed methods of managing collections in a data storage system may be implemented in other computer system configurations, including hand-held devices, multiprocessor systems, microprocessor-based or programmable consumer electronics, networked personal computers, minicomputers, mainframe computers, and the like. The disclosed methods of managing collections in a data storage system may also be practiced in distributed computing environments, where tasks are performed by remote processing devices that are linked through a communications network. In a distributed computing environment, program modules, such as collection-based data management module 114, may be located in both local and remote memory storage devices.

### Implementation of Exemplary Embodiments

As discussed in more detail below, methods of managing collections within a data storage system are disclosed. In one exemplary embodiment, a method of managing collections in a data storage system comprises the steps of closing an active collection if (i) a collection size of the active collection approaches or exceeds an optimum collection size or (ii) a replica of the active collection approaches or exceeds an available amount of disk space on a local disk; and replacing the closed active collection with a replacement active collection. The step of replacing the closed active collection with a replacement active collection may comprise (1) creating a new active collection so as to form a newly created active collection or (2) if present, activating an open collection so as to form a newly converted active collection.

In one exemplary embodiment, in response to receiving a request to store a new data object, the methods of managing collections within a data storage system may proceed through a series of method steps. In one exemplary embodiment, in response to receiving a request to store a new data object, a method of managing collections comprises (a) determining if placement of a newly received data object within a given active collection would cause (i) a collection size of the active collection to reach or exceed an optimum collection size or (ii) a replica of the active collection to reach or exceed an available amount of disk space on a local disk; (b) if placement of the newly received data object within the active collection would not cause (i) a collection size of the active collection to reach or exceed an optimum collection size or (ii) the replica of the active collection to reach or exceed an available amount of disk space on a local disk, placing the new data object into the active collection; and (c) if placement of the newly received data object within the active collection would cause (i) a collection size of the active collection to reach or exceed an optimum collection size or (ii) the replica of the active collection to reach or exceed an available amount of disk space on a local disk, closing the active collection, and replacing the closed active collection with a replacement active collection; and placing the new data object into the replacement active collection.

In another exemplary embodiment, in response to receiving a request to store a new data object, a method of managing collections comprises (a) determining if placement of a newly received data object within a given active collection would cause (i) a collection size of the active collection to reach or exceed an optimum collection size or (ii) a replica of the active collection to reach or exceed an available amount of disk space on a local disk; (b) if placement of the newly received data object within the active collection would not cause (i) a collection size of the active collection to reach or exceed an optimum collection size or (ii) the replica of the active collection to reach or exceed an available amount of disk space on a local disk, placing the new data object into the active collection; and (c) if placement of the newly received data object within the active collection would cause (i) a collection size of the active collection to reach or exceed an optimum collection size or (ii) the replica of the active collection to reach or exceed an available amount of disk space on a local disk, placing the new object into the active collection; closing the active collection after placing the new object into the active collection; and replacing the closed active collection with a replacement active collection.

In yet another exemplary embodiment, a given active collection may be closed independent of receiving a request to store a new data object. In this exemplary embodiment, a method of managing collections comprises (a) periodically checking (i) a collection size of each active collection and/or (ii) the available amount of disk space on a local disk for storing replica(s) for each active collection; (b) if (i) a collection size of the active collection exceeds an optimum collection size or (ii) an available amount of disk space on a local disk for storing replica(s) for each active collection falls below a minimum amount of disk space, closing the active collection; and replacing the closed active collection with a replacement active collection.

Exemplary methods of managing collections within a data storage system may further comprise creating N active collections wherein N is a whole number equal to a concurrency C of a computing system, wherein the term “concurrency” is used to represent a system parameter that controls the number of concurrent write ingest operations that can occur in parallel with one another on a given system; monitoring a collection size of each of the active collections; if an active collection approaches or exceeds an optimum collection size due to placement of a new data object into the active collection, closing the active collection; if an open collection is available, activating the open collection so as to form a newly converted active collection, for example, in response to a shortage of active collections; if an open collection is not available, creating a newly created active collection, for example, in response to a shortage of active collections; and placing the new data object into the (i) the newly converted active collection or (ii) the newly created active collection.

Exemplary methods may further comprise monitoring available disk space on a local disk. In some embodiments, methods may comprise monitoring available disk space on a local disk for a replica of an active collection; and if the replica of the active collection approaches or exceeds an available amount of disk space due to the placement of a new data object into the active collection, closing the active collection; if an open collection is available, activating the open collection so as to form a newly converted active collection and replace the closed the active collection; if an open collection is not available, creating a newly created active collection, and placing the new data object into (i) the newly converted active collection or (ii) the newly created collection.

Methods may further comprise monitoring available disk space on a local disk for write ingest of new data objects and/or replica(s) of new collections on the local disk; and if the available amount of disk space falls below a minimum threshold amount of disk space due to, for example, write ingest of new data objects and/or replica(s) of new collections onto the local disk, closing an open collection, if present (i.e., for systems comprising active, open and closed collections), and if not present (i.e., for systems comprising only active and closed collections), closing an active collection, and replacing the active collection as described above.

Further, if monitoring available disk space on a local disk indicates that the available amount of disk space on a local disk has increased to a desired level above a minimum threshold amount of disk space (e.g., 2× the minimum threshold amount of disk space) due to, for example, deletion of data objects thereon, one or more closed collections may be reopened to form one or more open collections (i.e., for systems comprising active, open and closed collections) or activated to form one or more active collections (i.e., for systems comprising only active and closed collections) depending on the states of collections utilized within a given system.

Methods for managing collections may further comprise monitoring a collection size of any closed collections, and if the collection size of one or more closed collections falls a predetermined amount below an optimum collection size due to, for example, object deletions, converting the one or more closed collection into one or more active collections (i.e., for systems comprising only active and closed collections) or one or more open collections (i.e., for systems comprising active, open and closed collections). For example, an administrator may set a predetermined amount to be a percentage, x, of the optimum collection size, Zₒ. The administrator may set x equal to 0.5 so that if the collection size of a given closed collection falls to ½ of the optimum collection size, the closed collection is converted into an active collection (i.e., for systems comprising only active and closed collections) or an open collection (i.e., for systems comprising active, open and closed collections).

In one exemplary embodiment, a method of managing collections comprises one or more of the following steps: initializing a storage system; creating one or more replicas of each active collection; storing the one or more replicas on a local disk; monitoring the concurrency C of the computing system, and if the concurrency C changes, reducing or increasing the number of active collections so that a total number of active collections, N (or N_{AC}) equals C; enabling reading or deletion of data object within any active collection, any open collection, and any closed collection.

The methods of managing collections may further comprise assigning a distinct ordinal value for each active collection (e.g., ordinal values ranging from 1 to N_{AC}); identifying an affinity, if any, for an incoming data object; an if an affinity of the incoming data object matches an ordinal value of a given active collection, placing the incoming data object into the given (i.e., the “matching”) active collection, as long as placement of the incoming data object into the given (i.e., the “matching”) active collection does not result in (i) a collection size of the active collection reaching or exceeding an optimum collection size or (ii) a replica of the active collection reaching or exceeding an available amount of disk space on a local disk.

Other methods of managing collections may comprise systematically distributing new data objects within all active collections using a load-balancing distribution scheme, such as a round-robin scheme. In one exemplary embodiment, a new data object is placed in a “current” active collection; the system then designates the next available active collection as the “current” active collection; the next data object received by the system is placed in the “current” active collection; the system continues to distribute incoming data objects until an incoming data object is place in each of the N active collections; then the system returns to the first active collection and redesignates the first active collection as the “current” active collection; and continues as described so as to evenly distribute data objects within all of the active collections. If placement of an incoming data object into the “current” active collection results in (i) a collection size of the “current” active collection reaching or exceeding an optimum collection size or (ii) a replica of the “current” active collection reaching or exceeding an available amount of disk space on a local disk, the system automatically (1) places the data object in the “current” active collection, closes the “current” active collection, creates a new replacement active collection, designates the next active collection as the “current” active collection, and proceeds as described above, or (2) closes the “current” active collection, creates a new replacement active collection, designates the new replacement active collection as the “current” active collection, places the data object in the new replacement active collection, and proceeds as discussed above (i.e., placing the next incoming data object in the next available active collection and so on until all of the N active collections receive an incoming data object).

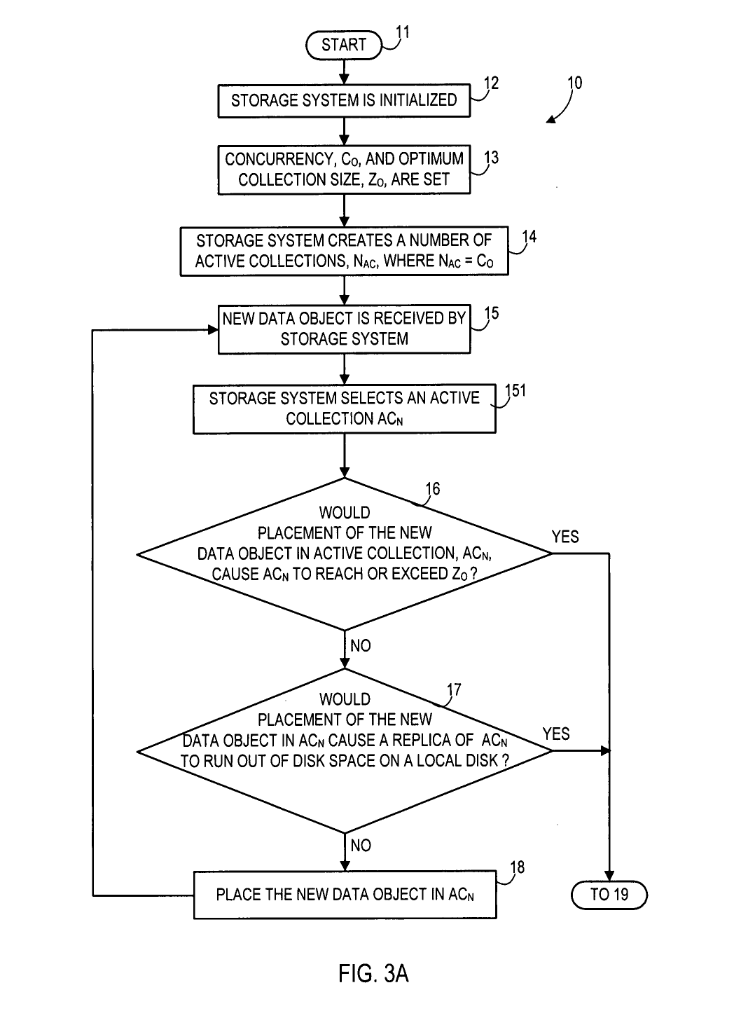

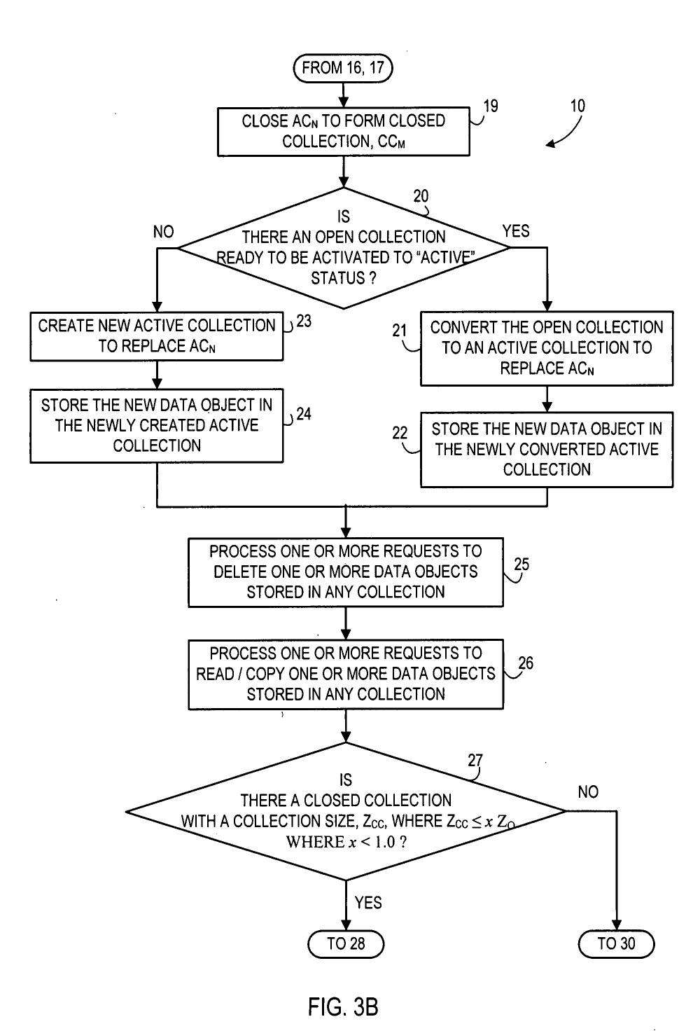

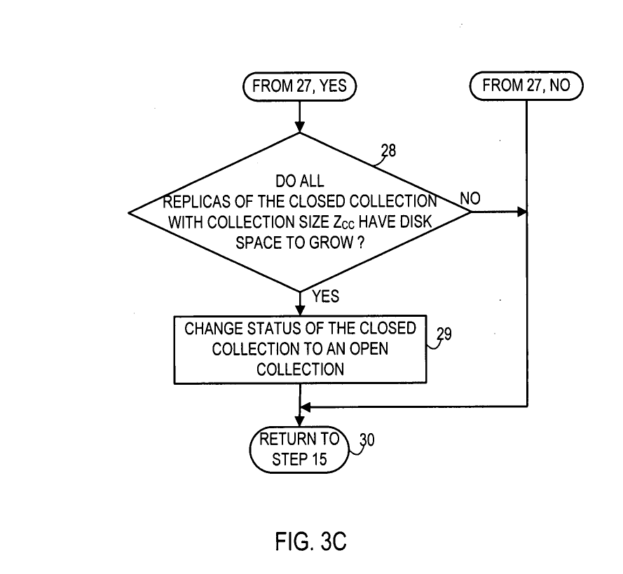

FIGS. 3A-3C represent an exemplary logic flow diagram showing exemplary steps for automatic management of collections of data objects within a data storage system. As shown in FIG. 3A, exemplary method 10 starts at block 11 and proceeds to step 12, where a storage system is initialized. From step 12, exemplary method 10 proceeds to step 13, wherein the concurrency, Cₒ, and optimum collection size, Zₒ, are set. The concurrency and optimum collection size may be set by a system administrator, for example, or may be determined using an algorithm which calculates an optimum collection size based on a number of system parameters. One suitable method for determining an optimum collection size is disclosed in U.S. Patent Publication No. 2006/0271547 A1, the subject matter of which is incorporated herein by reference in its entirety.

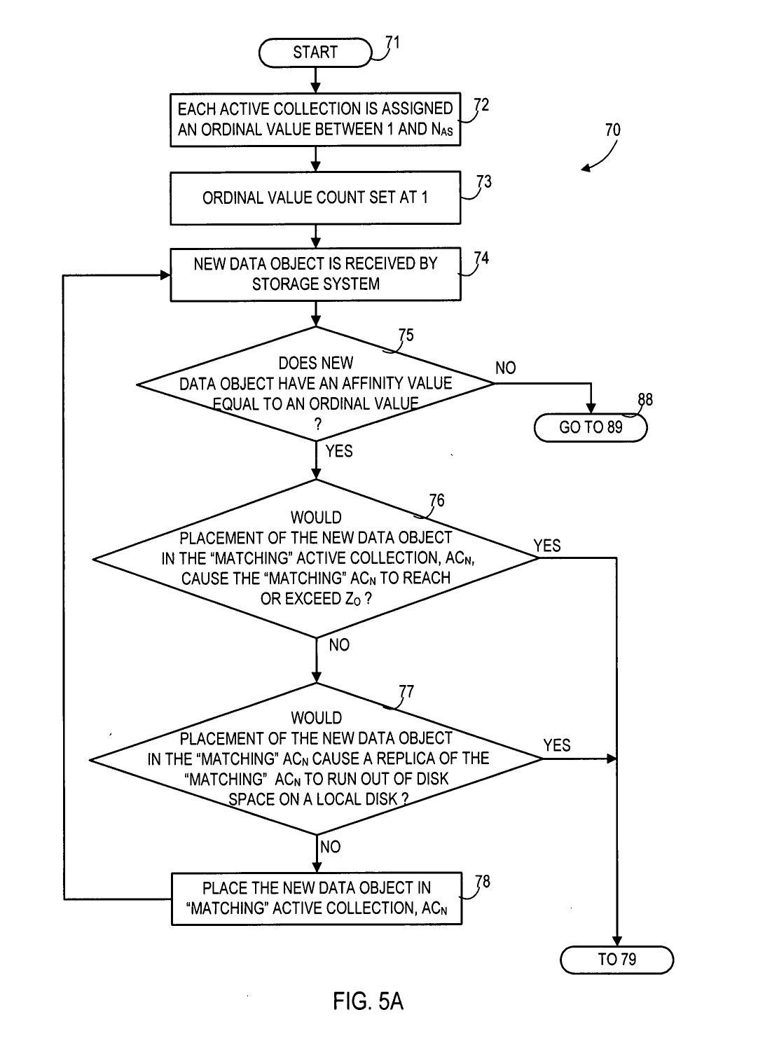

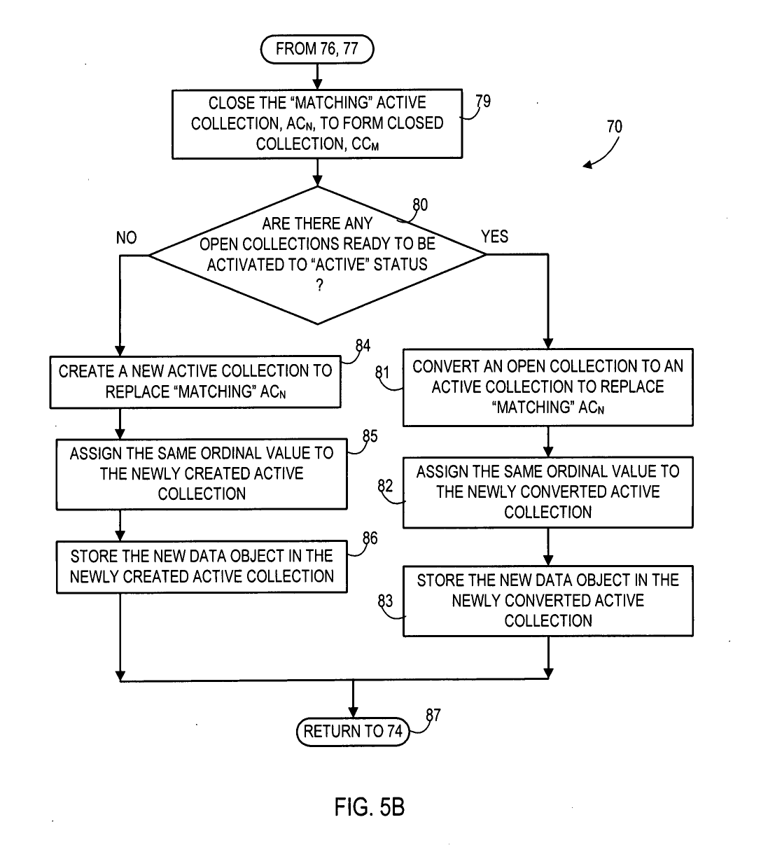

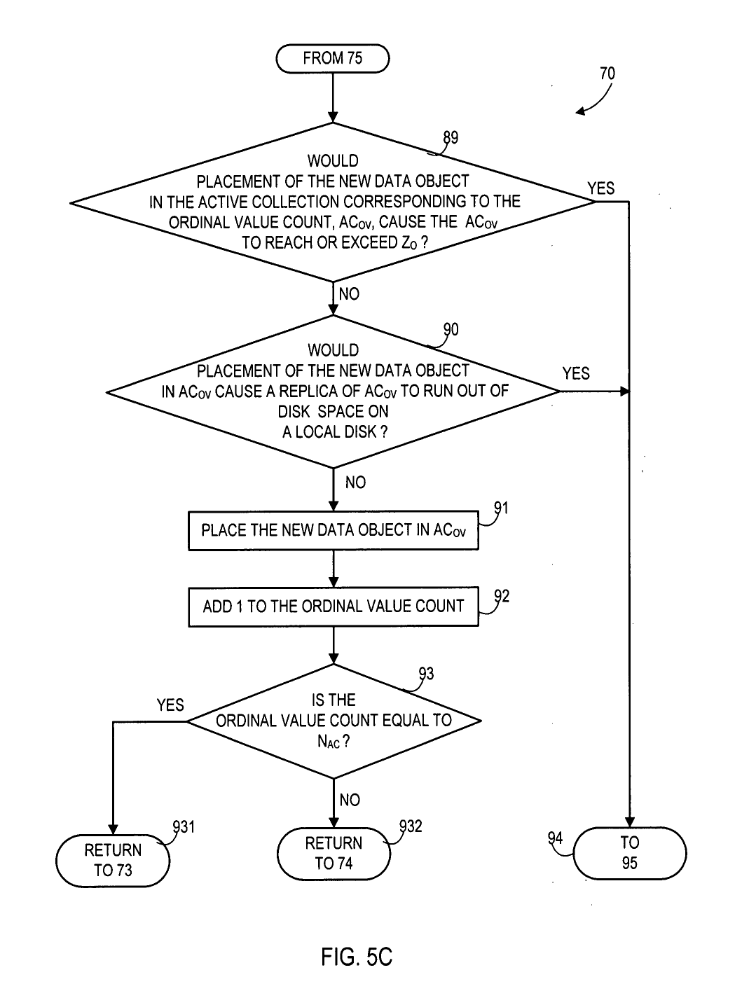

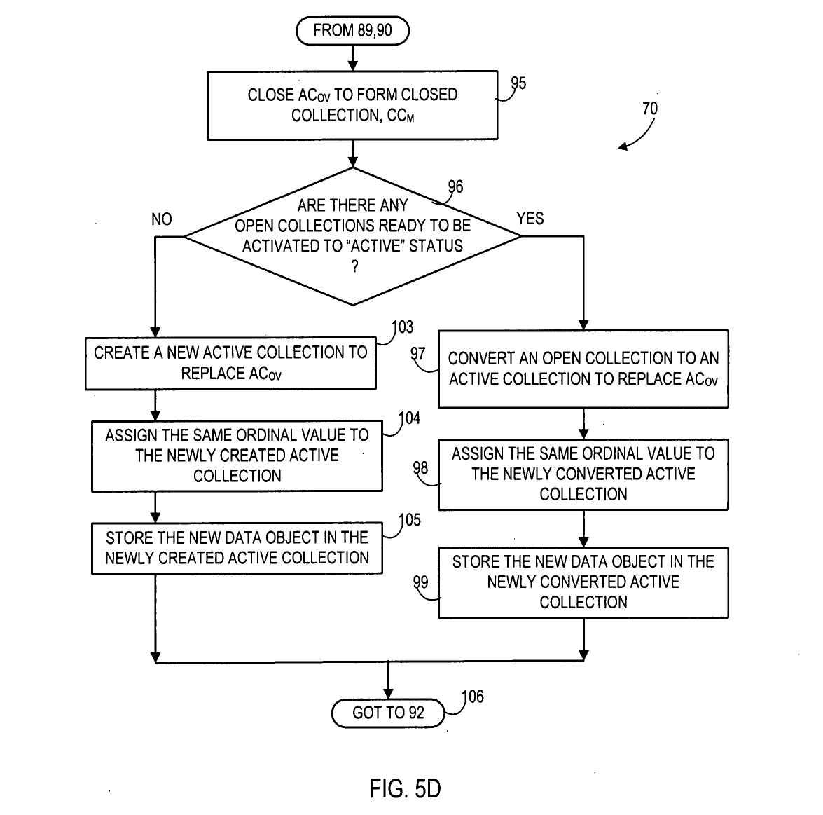

From step 13, exemplary method 10 proceeds to step 14, wherein the storage system creates a number of active collections, N_{AC}, where N_{AC} is equal to Cₒ. From step 14, exemplary method 10 proceeds to step 15, wherein a new data object is received by the storage system. From step 15, exemplary method 10 proceeds to step 151, wherein the storage system selects an active collection in which to place the new data object. In step 151, the storage system may select a given active collection based on any desired placement scheme (e.g., a round-robin placement scheme, a locality placement scheme based on an ordinal-affinity association, or a combination thereof as described below) (e.g., see, the exemplary controlled placement scheme depicted in FIGS. 5A-5D). From step 151, exemplary method 10 proceeds to decision block 16.

At decision block 16, a determination is made by application code whether placement of the new data object in active collection, AC_{N}, would cause active collection AC_{N} to reach or exceed optimum collection size Zₒ. If a determination is made that placement of the new data object in active collection AC_{N} would not cause active collection AC_{N} to reach or exceed optimum collection size Zₒ, exemplary method 10 proceeds to decision block 17. At decision block 17, a determination is made by application code whether placement of the new data object in active collection AC_{N} would cause a replica of active collection AC_{N} to run out of disk space on a local disk. If a determination is made that the placement of the new data object in active collection AC_{N} would not cause a replica of active collection AC_{N} to run out of disk space on a local disk, exemplary method 10 proceeds to step 18, wherein the new data object is placed in active collection AC_{N}. From step 18, exemplary method 10 returns to step 15 and proceeds as described herein.

Returning to decision block 16, if a determination is made by application code that placement of the new data object in active collection AC_{N} would cause active collection AC_{N} to reach or exceed an optimum collection size Zₒ, exemplary method 10 proceeds to step 19 as shown in FIG. 3B. In step 19, active collection AC_{N} is closed to form closed collection, CCₘ. Further, returning to decision block 17, if a determination is made by application code that placement of the new data object in active collection AC_{N} would cause a replica of active collection AC_{N} to run out of a disk space on a local disk, exemplary method also proceeds to step 19. From step 19, exemplary method 10 proceeds to decision block 20.

It should be noted, as discussed above, that in other exemplary embodiments, even if placement of the new data object in active collection AC_{N} would cause active collection AC_{N} to reach or exceed an optimum collection size Zₒ, the new data object is placed in active collection AC_{N} and subsequent to placement of the new data object in active collection AC_{N}, active collection AC_{N} is closed to form closed collection, CCₘ. In other words, although not shown in exemplary method 10, in some embodiments, step 18 could be prior to decision blocks 16 and 17 shown in FIG. 3A.

Further, it should be noted, as discussed above, that in other exemplary embodiments, closing of active collection AC_{N} is independent of a request to store a new data object. If, for example, an exemplary method determines that (i) a collection size of active collection AC_{N} exceeds an optimum collection size or (ii) an available amount of disk space on a local disk for storing replica(s) for each active collection (including active collection AC_{N}) falls below a minimum amount of disk space, active collection AC_{N} is closed, and replaced with a replacement active collection.

At decision block 20, if a determination is made by application code whether there are any open collections present in the storage system that can be activated to an “active” status (i.e., converted to an active collection). If a determination is made that there is an open collection available to be converted to an active collection, exemplary method 10 proceeds to step 21, wherein an open collection is converted to active collection so as to replace closed active collection AC_{N}. From step 21, exemplary method proceeds to step 22, wherein the new data object is stored in the newly converted active collection.

It should be noted that, in some embodiments, even if there are open collections present in the storage system, the system may choose to create a new active collection instead of activating an open collection to an “active” status based on one or more factors including, but not limited to, the locations of any existing open collections, and total number of collections. For example, there may be one open collection available, but the open collection resides on the same set of disks as the active collections. Activating the open collection does not keep the parallel write ingest at expected levels since the active collections reside on the same disks and therefore cannot receive objects in parallel. In this case, the system may decide to create a new collection rather than activate the existing open collection as long as the total number of collections is not too large.

Returning to decision block 20, if a determination is made that there are no open collections available for conversion to an active collection, exemplary method 10 proceeds to step 23, wherein a new active collection is created to replace closed active collection AC_{N}. From step 23, exemplary method 10 proceeds to step 24, wherein the new data object is stored in the newly created active collection.

From steps 22 and 24, exemplary method 10 proceeds to step 25, wherein one or more requests to delete one or more data objects stored in any collection is processed. For example, data objects within any active collection, any open collection, or any closed collection may be deleted in step 25. From step 25, exemplary method 10 proceeds to step 26, wherein one or more requests to read/copy one or more data objects stored on any collection are processed. Like the requests for deletion data objects, one or more data objects can be read/copied when stored on any active collection, any open collection, or any closed collection. From step 26, exemplary method 10 proceeds to decision block 27.

At decision block 27, if a determination is made by application code whether there are any closed collections present in the storage system that have a collection size Z_{cc}, wherein Z_{cc} is less that or equal to (x)(Zₒ), wherein x is less than 1.0. If a determination is made that there is one or more closed collections with a collection size Z_{cc} less than or equal to (x)(Zₒ), exemplary method 10 proceeds to decision block 28 as shown in FIG. 3C.

At decision block 28, if determination is made by application code whether all replicas of the closed collection (i.e., the closed collection having collection size Z_{cc} less than or equal to (x)(Zₒ)) have disk space to grow. If a determination is made that all replicas of the closed collection do have disk space to grow, exemplary method 10 proceeds to step 29, wherein the status of the closed collection is changed form that of a closed collection to an open collection. From step 29, exemplary method 10 proceeds to step 30, wherein exemplary method 10 returns to step 15 and proceeds as described above.

Returning to decision block 27 as shown in FIG. 3B, if a determination is made that there are no closed collections with a collection size Z_{cc} less than or equal to (x)(Zₒ) where x is less that 1.0, exemplary method 10 proceeds to step 30 as shown in FIG. 3C, and proceeds as described above. Further, returning to decision block 28, if a determination is made that all replicas of the closed collection (i.e., the closed collection having collection size Z_{cc} less than or equal to (x)(Zₒ)) do not have disk space to grow, exemplary method 10 proceeds to step 30 as shown in FIG. 3C, and proceeds as described above.

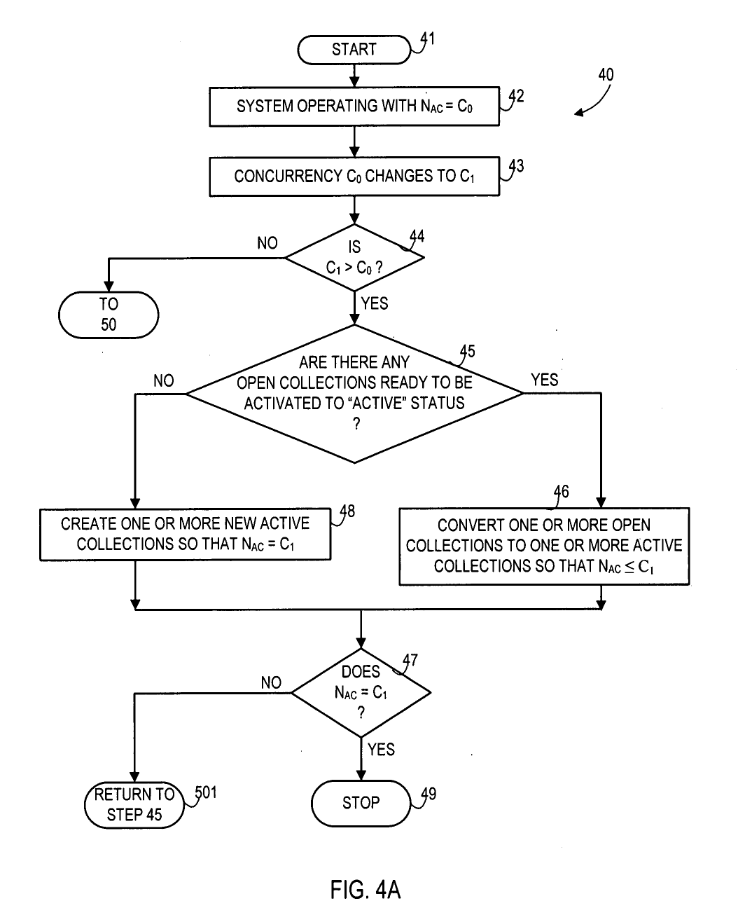

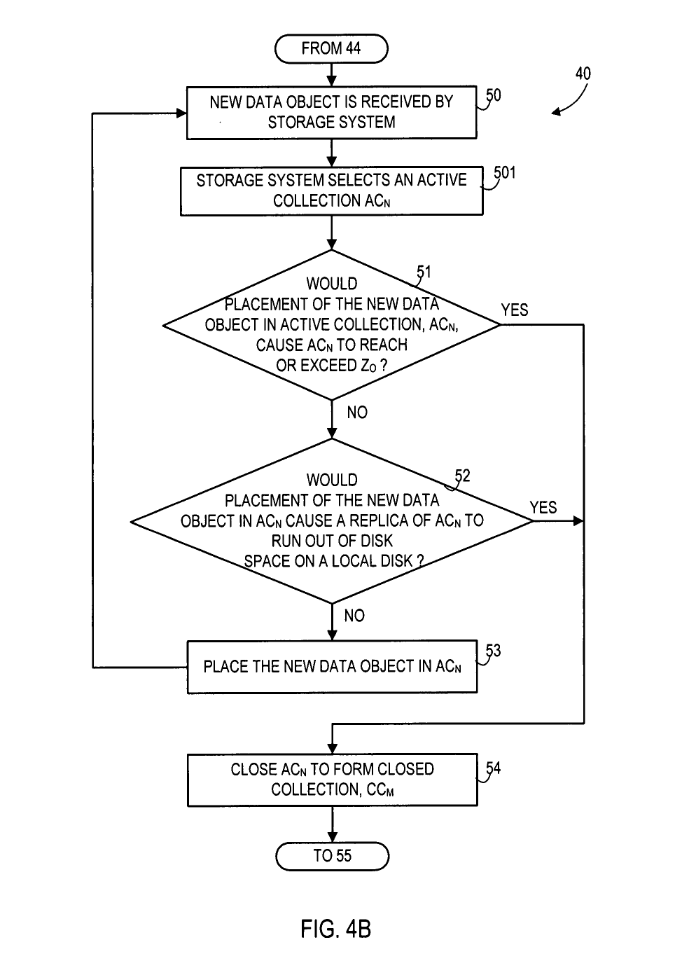

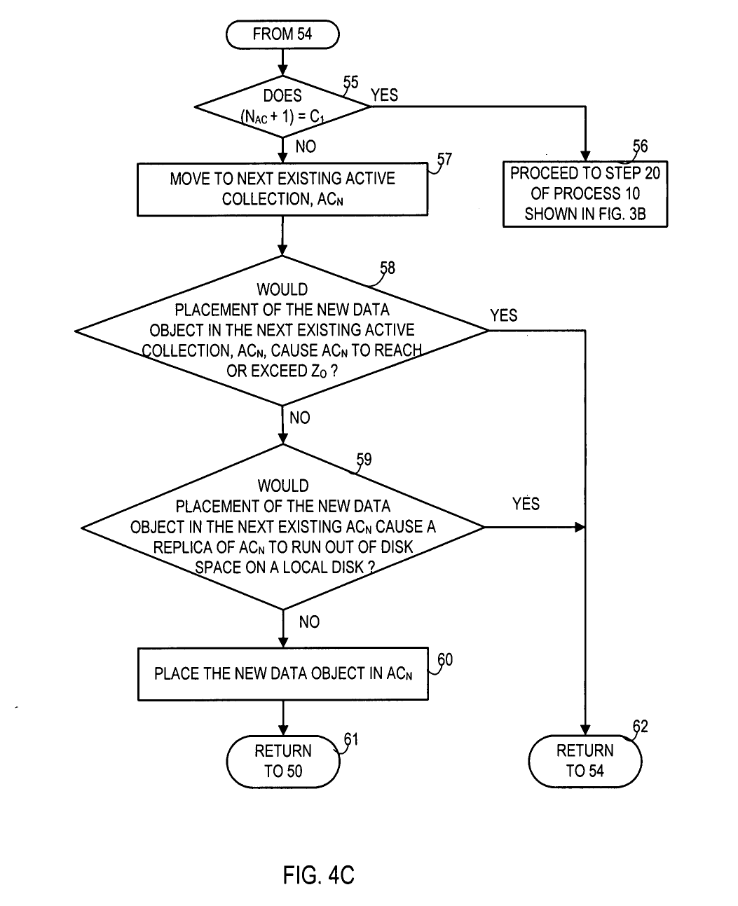

As discussed above, methods for managing collections and data objects within the disclosed storage systems desirably respond to changes to the concurrency (Cₒ) (i.e., the system parameter that controls the number of concurrent write ingest operations that can occur in parallel with one another on a given system) of a computing system. For example, a system administrator may decide to increase (or decrease) the concurrency of the computing system due to changes in the computing system (e.g., an increase in client applications used in the system). One exemplary method for compensating for changes in the concurrency setting of a computing system is shown in FIGS. 4A-4C.

FIGS. 4A-4C represent an exemplary logic flow diagram showing exemplary steps for adjusting a total number of collections so as to compensate for a change in the concurrency setting of the data storage system. As shown in FIG. 4A, exemplary method 40 starts at block 41 and proceeds to step 42, wherein a system is operating with a total number of active collections, N_{AC} equal to the concurrency Cₒ. From step 42, exemplary method 40 proceeds to step 43, wherein the concurrency Cₒ changes to C₁. From step 43, exemplary method 40 proceeds to decision block 44.

At decision block 44, a determination is made by a system administrator or application code whether the new concurrency C₁ is greater than the prior concurrency Cₒ. If a determination is made that the new concurrency C₁ is greater than the prior concurrency Cₒ, exemplary method 40 proceeds to decision block 45.

At decision block 45, a determination is made by application code whether there are any open collections available to be activated to “active” status (i.e., to be converted into active collections). If a determination is made that there are one or more open collections available that could be converted to one or more active collections, exemplary method 40 proceeds to step 46, wherein one or more open collections are converted to one or more active collections so that the total number of active collections N_{AC} is less than or equal to new concurrency C₁ (i.e., one or more open collections are converted to one or more active collections so that the total number of active collections N_{AC} does not exceed new concurrency C₁). (As noted above, although not shown in exemplary method 40, in some embodiments, the storage system may choose to create a new active collection instead of activating an open collection even if available.) From step 46, exemplary method 40 proceeds to decision block 47.

At decision block 47, a determination is made by application code whether the total number of active collection N_{AC} is equal to new concurrency C₁. If a determination is made that the number of active collections N_{AC} does not equal the new concurrency C₁, exemplary method 40 proceeds to step 501, wherein exemplary method 40 returns to decision block 45 and proceeds as described herein.

Returning to decision block 45, if a determination is made that there are no open collections available, exemplary method 40 proceeds to step 48, wherein one or more new active collections are created so that the total number of active collections N_{AC} equals the new concurrency C₁. From step 48, exemplary method 40 proceeds to decision block 47. If at decision block 47 a determination is made that the total number of active collections N_{AC} is equal to the new concurrency C₁, exemplary method 40 proceeds to step 49, wherein exemplary method 40 stops.

Returning to decision block 44, if a determination is made by application code that the new concurrency C₁ is not greater than the prior concurrency Cₒ, exemplary method 40 proceeds to step 50 as shown in FIG. 4B. In step 50, a new data object is received by the storage system. From step 50, exemplary method 40 proceeds to step 501, wherein the storage system selects an active collection in which to place the new data object. In step 501, the storage system may select a given active collection based on any desired placement scheme (e.g., a round-robin placement scheme, a locality placement scheme based on an ordinal-affinity association, or a combination thereof as described below) (e.g., see, the exemplary controlled placement scheme depicted in FIGS. 5A-5D). From step 501, exemplary method 40 proceeds to decision block 51.

At decision block 51, a determination is made by application code whether placement of the new data object in active collection, AC_{N}, would cause active collection AC_{N} to reach or exceed optimum collection size Zₒ. If a determination is made that placement of the new data object in active collection AC_{N} would not cause active collection AC_{N} to reach or exceed optimum collection size Zₒ, exemplary method 40 proceeds to decision block 52. At decision block 52, a determination is made by application code whether placement of the new data object in active collection AC_{N} would cause a replica of active collection AC_{N} to run out of disk space on a local disk. If a determination is made that the placement of the new data object in active collection AC_{N} would not cause a replica of active collection AC_{N} to run out of disk space on a local disk, exemplary method 40 proceeds to step 53, wherein the new data object is placed in active collection AC_{N}. From step 53, exemplary method 40 returns to step 50 and proceeds as described herein.

Returning to decision block 51, if a determination is made by application code that placement of the new data object in active collection AC_{N} would cause active collection AC_{N} to reach or exceed an optimum collection size Zₒ, exemplary method 40 proceeds to step 54. In step 54, active collection AC_{N} is closed to form closed collection, CCₘ. Further, returning to decision block 52, if a determination is made by application code that placement of the new data object in active collection AC_{N} would cause a replica of active collection AC_{N} to run out of a disk space on a local disk, exemplary method 40 also proceeds to step 54. From step 54, exemplary method 40 proceeds to decision block 55 as shown in FIG. 4C.

At decision block 55, a determination is made by application code whether the sum of the total number of active collections plus 1 (i.e., N_{AC}+1) is equal to the concurrency C₁. If a determination is made that (N_{AC}+1) is not equal to the new concurrency C₁, exemplary method 40 proceeds to step 57, wherein exemplary method 40 moves to the next existing active collection AC_{N} for possible placement of the new data object. From step 57, exemplary method 40 proceeds to decision block 58.

At decision block 58, a determination is made by application code whether placement of the new data object in the next existing active collection, AC_{N}, would cause the next existing active collection AC_{N} to reach or exceed optimum collection size Zₒ. If a determination is made that placement of the new data object in the next existing active collection AC_{N} would not cause active collection AC_{N} to reach or exceed optimum collection size Zₒ, exemplary method 40 proceeds to decision block 59. At decision block 59, a determination is made by application code whether placement of the new data object in the next existing active collection AC_{N} would cause a replica of the next existing active collection AC_{N} to run out of disk space on a local disk. If a determination is made that placement of the new data object in the next existing active collection AC_{N} would not cause a replica of the next existing active collection AC_{N} to run out of disk space on a local disk, exemplary method 40 proceeds to step 60, wherein the new data object is placed in the active collection AC_{N} (i.e., the next existing active collection AC_{N}). From step 60, exemplary method 40 proceeds to step 61, wherein exemplary method 40 returns to step 50 and proceeds as described herein.

Returning to decision block 58, if a determination is made by application code that placement of the new data object in the next existing active collection AC_{N} would cause the next existing active collection AC_{N} to reach or exceed an optimum collection size Zₒ, exemplary method 40 proceeds to step 62, wherein exemplary method 40 returns to step 54 as shown in FIG. 4B and proceeds as described herein. Further, returning to decision block 59, if a determination is made by application code that placement of the new data object in the next existing active collection AC_{N} would cause a replica of the next existing active collection AC_{N} to run out of a disk space on a local disk, exemplary method 40 also proceeds to step 62.

Returning to decision block 55, if a determination is made by application code that the sum of the total number of active collections N_{AC} Plus 1 (i.e., N_{AC}+1) is equal to the new concurrency C₁, exemplary method 40 proceeds to step 20 of exemplary method 10 as shown in FIG. 3B and proceeds as described above.

In an alternative embodiment, if the concurrency of the system is changed so that the new concurrency C₁ is less than the prior concurrency Cₒ, exemplary methods may immediately deactivate a number of active collections as opposed to waiting until the active collections reach an optimal collection size. Immediate deactivation of active collections may consist of converting one or more active collections into one or more open collections for systems comprising active, open and closed collections.

It should be understood that although the above-described exemplary embodiments describe storage systems in which the number of active collections (N_{AC}) equals the concurrency Cₒ, exemplary storage systems may also comprise a number of active collections (N_{AC}) greater than the concurrency Cₒ.

In some exemplary embodiments, methods of managing collections and data objects within a data storage system may further comprise method steps for controlled placement of data objects within active collections. As used herein, “controlled placement” is used to describe data object placement other than random placement of data objects. For example, data objects received by the storage system from a given client application may be grouped with other similar data objects a designated active collection so as to enable efficient storage, copying, and deleting of the related data objects. Other methods of controlled placement may comprise a systematic distribution of data objects within consecutive collections so as to approach equal distribution of data objects throughout all of the active collections.

Consequently, methods of managing collections and data objects may further comprise methods for distributing data objects so that (1) related data objects are grouped together in one or more associated collections and (2) data objects are essentially equally distributed to all of the active collections. One exemplary method of distributed data objects within a collection-based storage system is shown in FIGS. 5A-5D.

FIGS. 5A-5D represent an exemplary logic flow diagram showing exemplary steps for controlled placement of data objects within collections of a data storage system. As shown in FIG. 5A, exemplary method 70 starts at block 71 and proceeds to step 72, wherein each active collection is assigned an ordinal value between 1 and N_{AC}. From step 72, exemplary method 70 proceeds to step 73, wherein an ordinal value count is set at 1. From step 73, exemplary method 70 proceeds to step 74, wherein a new data object is received by the storage system. From step 74, exemplary method 70 proceeds to decision block 75.

At decision block 75, a determination is made by application code whether the new data object has an affinity value equal to an ordinal value of an active collection. If a determination is made that the data object does have an affinity value equal to an ordinal value of an active collection, exemplary method 70 proceeds to decision block 76.

At decision block 76, a determination is made by application code whether placement of the new data object in the “matching” active collection, AC_{N}, would cause the “matching” active collection AC_{N} to reach or exceed an optimum collection size Zₒ. If a determination is made that placement of the new data object in the “matching” active collection AC_{N} would not cause the “matching” active collection AC_{N} to reach or exceed optimum collection size Zₒ, exemplary method 70 proceeds to decision block 77. At decision block 77, a determination is made by application code whether placement of the new data object in the “matching” active collection AC_{N} would cause a replica of the “matching” active collection AC_{N} to run out of disk space on a local disk. If a determination is made that the placement of the new data object in the “matching” active collection AC_{N} would not cause a replica of the “matching” active collection AC_{N} to run out of disk space on a local disk, exemplary method 70 proceeds to step 78, wherein the new data object is placed in the “matching” active collection AC_{N}. From step 78, exemplary method 10 returns to step 74 and proceeds as described herein.

Returning to decision block 76, if a determination is made by application code that placement of the new data object in the “matching” active collection AC_{N} would cause the “matching” active collection AC_{N} to reach or exceed an optimum collection size Zₒ, exemplary method 70 proceeds to step 79 as shown in FIG. 5B. In step 79, the “matching” active collection AC_{N} is closed to form closed collection, CCₘ. Further, returning to decision block 77, if a determination is made by application code that placement of the new data object in the “matching” active collection AC_{N} would cause a replica of the “matching” active collection AC_{N} to run out of a disk space on a local disk, exemplary method 70 also proceeds to step 79. From step 79, exemplary method 70 proceeds to decision block 80.

At decision block 80, a determination is made by application code whether there are any open collections present in the storage system that can be activated to an “active” status (i.e., converted to an active collection). If a determination is made that there is an open collection available to be converted to an active collection, exemplary method 70 proceeds to step 81, wherein an open collection is converted to an active collection so as to replace closed “matching” active collection AC_{N}. From step 81, exemplary method proceeds to step 82, wherein the same ordinal value previously assigned to closed “matching” active collection AC_{N} is assigned to the newly converted active collection. From step 82, exemplary method 70 proceeds to step 83, wherein the new data object is stored in the newly converted active collection.

Returning to decision block 80, if a determination is made that there are no open collections available for conversion to an active collection, exemplary method 70 proceeds to step 84, wherein a new active collection is created to replace closed “matching” active collection AC_{N}. From step 84, exemplary method proceeds to step 85, wherein the same ordinal value previously assigned to closed “matching” active collection AC_{N} is assigned to the newly created active collection. From step 85, exemplary method 70 proceeds to step 86, wherein the new data object is stored in the newly created active collection.

From steps 83 and 86, exemplary method 70 proceeds to step 87, wherein exemplary method 70 returns to step 74 and proceeds as described herein.

Returning to decision block 75, if a determination is made by application code that the new data object does not have an affinity value equal to an ordinal value of any active collection, exemplary method 70 proceeds to step 88, wherein exemplary method 70 proceeds to step 89 as shown in FIG. 5C.

At decision block 89, a determination is made by application code whether placement of the new data object in the an active collection corresponding to the ordinal value count, AC_{OV}, would cause the active collection corresponding to the ordinal value count, AC_{OV}, to reach or exceed an optimum collection size Zₒ. If a determination is made that placement of the new data object in the active collection AC_{OV} would not cause the active collection AC_{OV} to reach or exceed optimum collection size Zₒ, exemplary method 70 proceeds to decision block 90. At decision block 90, a determination is made by application code whether placement of the new data object in the active collection AC_{OV} would cause a replica of the active collection AC_{OV} to run out of disk space on a local disk. If a determination is made that the placement of the new data object in the active collection AC_{OV} would not cause a replica of the active collection AC_{OV} to run out of disk space on a local disk, exemplary method 70 proceeds to step 91, wherein the new data object is placed in the active collection AC_{OV}. From step 91, exemplary method 70 proceeds to step 92, wherein 1 is added to the ordinal value count. From step 92, exemplary method 70 proceeds to decision block 93.

At decision block 93, if a determination is made by application code whether the ordinal value count equals the total number of active collections N_{AC}. If a determination is made that the ordinal value count does equal the number of total of active collections N_{AC}, exemplary method 70 proceeds to step 931, wherein exemplary method 70 returns to step 73 as shown in FIG. 5A and proceeds as described herein. If a determination is made that the ordinal value count does not equal the number of total active collections N_{AC}, exemplary method 70 proceeds to step 932, wherein exemplary method 70 returns to step 74 as shown in FIG. 5A and proceeds as described herein.

Returning to decision block 89, if a determination is made by application code that placement of the new data object in the an active collection corresponding to the ordinal value count, AC_{OV}, would cause the active collection corresponding to the ordinal value count, AC_{OV}, to reach or exceed an optimum collection size Zₒ, exemplary method 70 proceeds to step 95 as shown in FIG. 5D. In step 95, active collection corresponding to the ordinal value count, AC_{OV}, is closed to form closed collection, CCₘ. Further, returning to decision block 90, if a determination is made by application code that placement of the new data object in the active collection AC_{OV} would cause a replica of the active collection AC_{OV} to run out of a disk space on a local disk, exemplary method 70 also proceeds to step 95. From step 95, exemplary method 70 proceeds to decision block 96.

At decision block 96, a determination is made by application code whether there are any open collections present in the storage system that can be activated to an “active” status (i.e., converted to an active collection). If a determination is made that there is an open collection available to be converted to an active collection, exemplary method 70 proceeds to step 97, wherein an open collection is converted to an active collection so as to replace closed active collection AC_{OV}. From step 97, exemplary method 70 proceeds to step 98, wherein the same ordinal value previously assigned to closed active collection AC_{OV} is assigned to the newly converted active collection. From step 98, exemplary method 70 proceeds to step 99, wherein the new data object is stored in the newly converted active collection.

Returning to decision block 96, if a determination is made that there are no open collections available for conversion to an active collection, exemplary method 70 proceeds to step 103, wherein a new active collection is created to replace closed active collection AC_{OV}. From step 103, exemplary method 70 proceeds to step 104, wherein the same ordinal value previously assigned to closed active collection AC_{OV} is assigned to the newly created active collection. From step 104, exemplary method 70 proceeds to step 105, wherein the new data object is stored in the newly created active collection.

From steps 99 and 105, exemplary method 70 proceeds to step 106, wherein exemplary method 70 returns to step 92 as shown in FIG. 5C and proceeds as described herein.

It should be noted that although exemplary method 70 describes the simultaneous use of two distinct schemes for controlled placement of new data objects within active collections (i.e., (1) placement of a new data based on an affinity of the new data object to a given active collection, and (2) placement of a new data based on an even distribution scheme where affinity of the new data object to a given active collection does not exist or is not taken into account), methods of managing collection described herein may only comprise one of the above-described controlled placement schemes (e.g., either (1) or (2)).

In addition to the above-described methods of managing collection in a data storage system, computer readable medium having stored thereon computer-executable instructions for performing the above-described methods are also disclosed. In one exemplary embodiment, the computer readable medium comprises a computer readable medium having stored thereon computer-executable instructions for managing collections of data on a network, the computer-executable instructions utilizing an active collection replacement function that automatically (i) closes an active collection if a collection size of the active collection reaches or exceeds an optimum collection size, and (ii) replaces the closed active collection with a replacement active collection.

The computer readable medium desirably comprises computer-executable instructions for performing one or more of the following method steps: initializing a storage system; creating N active collections wherein N is a whole number equal to a concurrency C of the computing system; creating one or more replicas of each active collection; storing the one or more replicas on a local disk; monitoring the concurrency of the computing system, and if the concurrency changes, reducing or increasing the number of active collections so that N=C; and enabling reading or deletion of data objects within active collections, open collections and closed collections.

In other exemplary embodiments, computer readable medium desirably comprises computer-executable instructions monitoring a collection size for each active collection; monitoring the presence of any open collections within the storage system; and if a collection size of an active collection approaches or exceeds an optimum collection size due to placement of a new data object into the active collection, closing the active collection; if an open collection is available, activating the open collection so as to form a newly converted active collection; if an open collection is not available, creating a new active collection; and placing the new data object into (i) the newly converted active collection or (ii) the new active collection.

Computer readable medium may further comprise computer-executable instructions for monitoring an available amount of disk space on a local disk for one or more replicas of an active collection; and if one or more replicas of the active collection approaches or exceeds the available amount of disk space on the local disk due to placement of a new data object into the active collection, closing the active collection; if an open collection is available, activating the open collection so as to form a newly converted active collection; if an open collection is not available, creating a new active collection; and placing the new data object into (i) the newly converted active collection or (ii) the new active collection.

Computer readable medium may further comprise computer-executable instructions for monitoring an available amount of disk space on a local disk; and if the available amount of disk space falls below a minimum threshold amount of disk space due to, for example, write ingest of new data objects and/or replica(s) of new data objects onto the local disk, the computer-executable instructions close an open collection, if present (i.e., for systems comprising active, open and closed collections), and if not present (i.e., for systems comprising only active and closed collections or for systems comprising active, open and closed collections), close an active collection, and replace the active collection as described above.

Computer readable medium may further comprise computer-executable instructions for monitoring an available amount of disk space on a local disk wherein if monitoring available disk space on a local disk indicates that the available amount of disk space on a local disk has increased to a desired level above a minimum threshold amount of disk space (e.g., 2× the minimum threshold amount of disk space) due to, for example, deletion of data objects thereon, the computer-executable instructions (i) reopen one or more closed collections to form one or more open collections (i.e., for systems comprising active, open and closed collections) or (ii) activate one or more closed collections to form one or more active collections (i.e., for systems comprising only active and closed collections).

In order to enable recycling of closed collections, computer readable medium may comprise computer-executable instructions for monitoring a collection size of closed collections, and if the collection size of a closed collection falls a predetermined amount below the optimum collection size, converting the closed collection into an open collection.

In order to enable controlled placement of data objects within a given storage system, computer readable medium may further comprise computer-executable instructions for assigning a distinct ordinal for each active collection; identifying an affinity of an incoming data object; and if an affinity of an incoming data object matches the ordinal of a given active collection, placing the incoming data object into the given active collection.

Computing systems are also disclosed herein. An exemplary computing system contains at least one application module usable on the computing system, wherein the at least one application module comprises application code loaded thereon, wherein the application code performs any of the above-described methods of managing collections in a data storage system. The application code may be loaded onto the computing system using any of the above-described computer readable medium having thereon computer-executable instructions for managing collections in a data storage system as described above.

In one exemplary computing system, the computing system comprises at least one application module usable on the computing system, wherein the at least one application module comprises application code for performing a collections-based storage method, the method comprising the steps of (a) creating N active collections wherein N is a whole number equal to a concurrency C of the computing system; (b) monitoring a collection size for each of the active collections; (c) if an active collection approaches or exceeds an optimum collection size due to placement of a new data object into the active collection, closing the active collection; (d) if an open collection is available, activating the open collection so as to form a newly converted active collection; (e) if an open collection is not available, creating a new active collection; and (f) placing the new data object into (i) the newly converted active collection or (ii) the new active collection.

In other exemplary computing systems, the computing system may further comprising application code for (a) monitoring an available amount of disk space on a local disk for a replica of the active collection to grow; and (b) if the replica of the active collection approaches or exceeds the available amount of disk space on the local disk due to placement of a new data object into the active collection, closing the active collection; (c) if an open collection is available, activating the open collection so as to form a newly converted active collection; (d) if an open collection is not available, creating a new active collection; and (e) placing the new data object into (i) the newly converted active collection or (ii) the new active collection.

In other exemplary computing systems, the computing system may further comprising application code for (a) monitoring a collection size of closed collections, and (b) if the collection size of a closed collection falls a predetermined amount below the optimum collection size, converting the closed collection into an open collection.

While the specification has been described in detail with respect to specific embodiments thereof, it will be appreciated that those skilled in the art, upon attaining an understanding of the foregoing, may readily conceive of alterations to, variations of, and equivalents to these embodiments. Accordingly, the scope of the disclosed methods, computer readable medium, and computing systems should be assessed as that of the appended claims and any equivalents thereto.

What is claimed is:

1. A computer readable medium having stored thereon computer-executable instructions for managing collections of data on a network, said computer-executable instructions utilizing an active collection replacement function that automatically (i) closes an active collection if a collection size of the active collection reaches or exceeds an optimum collection size, and (ii) replaces the closed active collection with a replacement active collection.

2. The computer readable medium of claim 1, further comprising computer-executable instructions for:
initializing a storage system; and
creating N active collections wherein N is a whole number equal to or greater than a concurrency C of the computing system.

3. The computer readable medium of claim 1, further comprising computer-executable instructions for:
monitoring a collection size for each active collection; and
if a collection size of an active collection approaches or exceeds an optimum collection size due to placement of a new data object into the active collection,
closing the active collection.

4. The computer readable medium of claim 1, further comprising computer-executable instructions for:
monitoring a collection size for each active collection;
monitoring the presence of any open collections within the storage system; and
if a collection size of an active collection approaches or exceeds an optimum collection size due to placement of a new data object into the active collection,
closing the active collection;
if an open collection is available, activating the open collection so as to form a newly converted active collection;
if an open collection is not available, creating a new active collection; and
placing the new data object into (i) the newly converted active collection or (ii) the new active collection.

5. The computer readable medium of claim 1, further comprising computer-executable instructions for:
monitoring an available amount of disk space on a local disk for one or more replicas of the active collection; and
if one or more replicas of the active collection approaches or exceeds the available amount of disk space on the local disk due to placement of a new data object into the active collection,
closing the active collection;
if an open collection is available, activating the open collection so as to form a newly converted active collection;
if an open collection is not available, creating a new active collection; and
placing the new data object into (i) the newly converted active collection or (ii) the new active collection.

6. The computer readable medium of claim 1, further comprising computer-executable instructions for:
monitoring a collection size of closed collections, and
if the collection size of a closed collection falls a predetermined amount below the optimum collection size,
converting the closed collection into an open collection or an active collection.

7. The computer readable medium of claim 2, further comprising computer-executable instructions for:
monitoring the concurrency of the computing system, and
if the concurrency changes,
reducing or increasing the number of active collections so that N=C.

8. The computer readable medium of claim 1, further comprising computer-executable instructions for:
enabling reading or deletion of data objects within active collections, open collections and closed collections.

9. The computer readable medium of claim 1, further comprising computer-executable instructions for:
assigning a distinct ordinal value for each active collection;
identifying an affinity value of an incoming data object; and
if an affinity value of an incoming data object matches the ordinal value of a given active collection,
placing the incoming data object into the given active collection.

10. The computer readable medium of claim 1, further comprising computer-executable instructions for:
controlled placement of data objects into all active collections.

11. A computing system containing at least one application module usable on the computing system, wherein the at least one application module comprises application code loaded thereon from the computer readable medium of claim 1.

12. A method of managing collections of data in a data storage system, said method comprising the steps of:
closing an active collection if (i) a collection size of the active collection approaches or exceeds an optimum collection size or (ii) a replica of the active collection approaches or exceeds an available amount of disk space on a local disk; and
replacing the closed active collection with a replacement active collection.

13. The method of claim 12, further comprising:
determining if placement of a newly received data object within the active collection would cause (i) a collection size of the active collection to reach or exceed an optimum collection size or (ii) the replica of the active collection to reach or exceed an available amount of disk space on a local disk;
if placement of the newly received data object within the active collection would not cause (i) a collection size of the active collection to reach or exceed an optimum collection size or (ii) the replica of the active collection to reach or exceed an available amount of disk space on a local disk,
placing the new data object into the active collection; and
if placement of the newly received data object within the active collection would cause (i) a collection size of the active collection to reach or exceed an optimum collection size or (ii) the replica of the active collection to reach or exceed an available amount of disk space on a local disk,
closing the active collection, and
replacing the closed active collection with a replacement active collection; and
placing the new data object into the replacement active collection.

14. The method of claim 12, wherein the replacing step comprises creating a new active collection.

15. The method of claim 12, further comprising:
in response to a closed collection falling a predetermined amount below the optimum collection size,
converting the closed collection into an open collection or an active collection.

16. The method of claim 12, wherein the replacing step comprises activating an open collection so as to form a newly converted active collection.

17. A computer readable medium having stored thereon computer-executable instructions for performing the method of claim 12.

18. A computing system containing at least one application module usable on the computing system, wherein the at least one application module comprises application code for performing a collections-based storage method, said method comprising the steps of:
creating N active collections wherein N is a whole number equal to a concurrency C of the computing system;
monitoring a collection size for each of the active collections;
if an active collection approaches or exceeds an optimum collection size due to placement of a new data object into the active collection,
closing the active collection;
if an open collection is available, activating the open collection so as to form a newly converted active collection;
if an open collection is not available, creating a new active collection; and
placing the new data object into (i) the newly converted active collection or (ii) the new active collection.

19. The computing system of claim 18, further comprising application code for:
monitoring an available amount of disk space on a local disk for a replica of the active collection to grow; and
if the replica of the active collection approaches or exceeds the available amount of disk space on the local disk due to placement of a new data object into the active collection,
closing the active collection;
if an open collection is available, activating the open collection so as to form a newly converted active collection;
if an open collection is not available, creating a new active collection; and
placing the new data object into (i) the newly converted active collection or (ii) the new active collection.

20. The computing system of claim 18, further comprising application code for:
monitoring a collection size of closed collections, and
if the collection size of a closed collection falls a predetermined amount below the optimum collection size,
converting the closed collection into an open collection or an active collection.
